(19) United States
(12) Patent Application Publication
(10) Pub. No.: US 2017/0082267 A1
(43) Pub. Date: Mar. 23, 2017

(54) FRAMELESS SCREEN FOR TILEABLE DISPLAY PANEL

(71) Applicant: Google Inc., Mountain View, CA (US)

(72) Inventors: Jacques Gagne, Los Gatos, CA (US); Adam E. Norton, Palo Alto, CA (US); Stephen D. Dorow, San Francisco, CA (US); Kenneth G. Robertson, San Jose, CA (US)

(21) Appl. No.: 14/857,524

(22) Filed: Sep. 17, 2015

(51) Int. Cl. F21V 11/16

(52) U.S. Cl. CPC F21V 11/16

(57) ABSTRACT

A display panel comprises a display layer including a plurality of pixel arrays offset from each other by spacing regions and a screen layer disposed over the display layer with each of the pixel arrays aligned to project an image portion onto a corresponding portion of the screen layer. The screen layer includes a transparent substrate and an array of upper spacer supports to support the transparent substrate a first fixed distance from the display layer. Each of the upper spacer supports is positioned on one of the spacing regions.

### TECHNICAL FIELD

This disclosure relates generally to display panels, and in particular but not exclusively, relates to seamless tiling of display panels.

### BACKGROUND INFORMATION

Large wall displays can be prohibitively expensive as the cost to manufacture display panels rises exponentially with monolithic display area. This exponential rise in cost arises from the increased complexity of large monolithic displays, the decrease in yields associated with large displays (a greater number of components must be defect free for large displays), and increased shipping, delivery, and setup costs. Tiling smaller display panels to form larger multi-panel displays can help reduce many of the costs associated with large monolithic displays.

FIGS. 1A and 1B illustrate how tiling multiple smaller, less expensive display panels 100 together can achieve a large multi-panel display 105, which may be used as a large wall display. The individual images displayed by each display panel 100 may constitute a sub-portion of the larger overall composite image collectively displayed by multi-panel display 105. While multi-panel display 105 can reduce costs, visually it has a major drawback. Each display panel 100, includes a front side exposed bezel 110 around its periphery. Bezel 110 is a mechanical structure that houses pixel region 115 in which the display pixels are disposed. In recent years, manufactures have reduced the thickness of bezel 110 considerably to less than 2 mm. However, even these thin bezel trims are still very noticeable to the naked eye, distract the viewer, and otherwise detract from the overall visual experience.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. The drawings are not necessarily to scale, emphasis instead being placed upon illustrating the principles being described.

FIGS. 1A & 1B (PRIOR ART) illustrate conventional display panel tiling.

FIG. 2 is a perspective view illustrating functional layers of a tileable display panel, in accordance with an embodiment of the disclosure.

FIG. 3A is a cross-sectional view of functional layers of a tileable display panel, in accordance with an embodiment of the disclosure.

FIG. 3B illustrates how tileable display panels can be tiled to form larger seamless displays, in accordance with an embodiment of the disclosure.

FIG. 4A is a cross-sectional illustration (side view) of a portion of a tileable display panel having a frameless display screen, in accordance with an embodiment of the disclosure.

FIG. 4B is a cross-sectional illustration (top view) of a tileable display panel having a frameless display screen, in accordance with an embodiment of the disclosure.

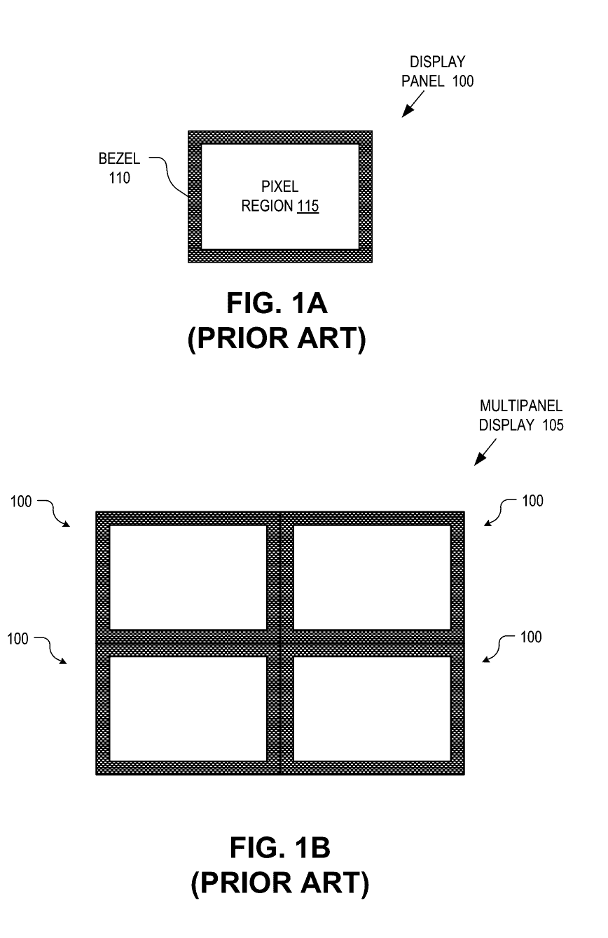

### DETAILED DESCRIPTION

Embodiments of an apparatus and system for a tileable display panel having a frameless screen are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

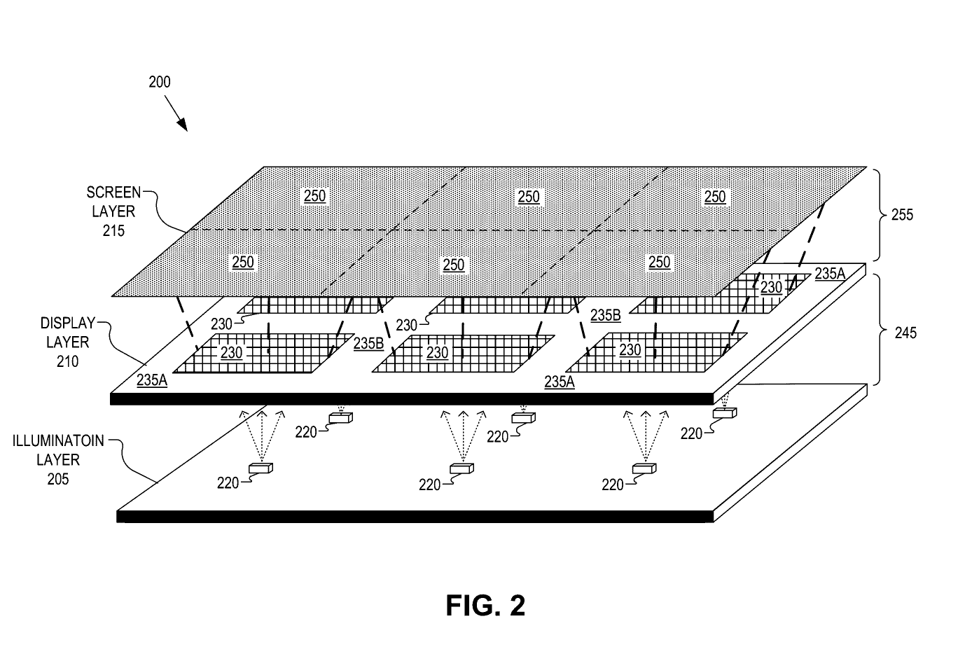

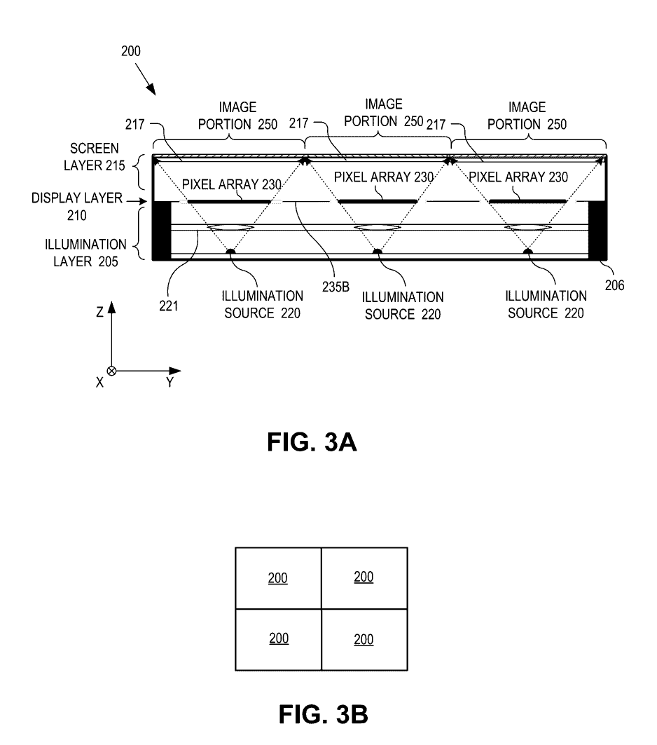

FIGS. 2 and 3A illustrate functional layers of a tileable display panel 200 having a frameless screen, in accordance with an embodiment of the disclosure. FIG. 2 is a perspective view of the layers of display panel 200 while FIG. 3A is a cross-section view of the same. The illustrated embodiment of display panel 200 includes an illumination layer 205, a display layer 210, and a screen layer 215. The illustrated embodiment of illumination layer 205 includes an array of illumination sources 220 and a lensing layer 221 (only illustrated in FIG. 3A for clarity). The illustrated embodiment of display layer 210 includes transmissive pixel arrays 230 separated from each other by spacing regions 235A and 235B (collectively 235). The illustrated embodiment of screen layer 215 is divided into regions for displaying image portions 250 of an overall unified image. Screen layer 215 may include a number of optical sub-layers, such as collimating and diffusing layers disposed over a transparent substrate, spacer supports, or otherwise. For example, in one embodiment, screen layer 215 includes an array of Fresnel lenses 217 (see FIG. 3A), with each Fresnel lens 217 centered over a corresponding pixel array 230. Tileable display panel 200 is made up of a plurality of pixlets, each including an illumination source 220, transmissive pixel array 230, a Fresnel lens 217, and a screen region for displaying an image portion 250 all aligned within a column through display 200.

In the illustrated embodiment, each illumination source 220 is aligned under a corresponding pixel array 230 to illuminate a backside of the corresponding pixel array with lamp light. Illumination sources 220 may be implemented as independent light sources (e.g., color or monochromatic LEDs, quantum dots, etc.) that emit light with a defined angular spread or cone to fully illuminate their corresponding transmissive pixel array 230 residing above on display layer 210. The display sources 220 and transmissive pixel arrays 230 are separated from each other by a fixed distance 245 (e.g., 8 mm). This separation may be achieved using a transparent intermediary (e.g., glass, plastic, air gap, etc.) and may further include one or more lensing layers 221 (including lenses, apertures, beam confiners, etc.) to control or manipulate the angular extent and cross-sectional shape of the lamp light emitted from illumination sources 220. In one embodiment, an illumination controller may be coupled to illumination sources 220 to control their illumination intensity. Illumination layer 205 may include a substrate upon which illumination sources 220 are disposed.

Transmissive pixel arrays 230 are disposed on the display layer 210 and each includes an array of transmissive pixels (e.g., 120 pixels by 120 pixels). In one embodiment, the transmissive pixels may be implemented as backlit liquid crystal pixels. Each transmissive pixel array 230 is an independent display array that is separated from adjacent transmissive pixel arrays 230 by spacing regions 235 on display layer 210. The internal spacing regions 235B that separate adjacent pixel arrays 230 from each other may be twice the width as the perimeter spacing regions 235A that separate a given pixel array 230 from an outer edge of display layer 210. In one embodiment, the internal spacing regions 235B have a width of 10 mm while the perimeter spacing regions 235A have a width of 5 mm. Of course, other dimensions may be implemented.

As illustrated, transmissive pixel arrays 230 are spaced across display layer 210 in a matrix with spacing regions 235 separating each transmissive pixel array 230. In one embodiment, transmissive pixel arrays 230 each represent a separate and independent array of display pixels (e.g., backlit LCD pixels). Spacing region 235 are significantly larger than the inter-pixel separation between pixels of a given transmissive pixel array 230. Spacing regions 235 provide improved flexibility for routing signal lines or the inclusion of additional circuitry, such as a display controller, for controlling operation of transmissive pixel arrays 230. Spacing regions 235A that reside along the exterior perimeter of display layer 210 also provide space for the concealed bezel trim 206 of display 200. Bezel trim 206 operates as the sides of the housing for display 200 but is overlapped by portions of screen layer 215. The spacing regions 235A that reside along the exterior perimeter also provide space for power and/or communication ports. The divergence angle of the display light output from transmissive pixel arrays 230 along with the separation between pixel arrays 230 and the imaging plane of screen layer 215 is selected such that image portions 250 are magnified or expanded to overlap and conceal perimeter bezel trim 206 and spacing regions 235.

Although FIG. 2 illustrates display layer 210 as including six transmissive pixel arrays 230 arranged into two rows and three columns, it should be appreciated that various implementations of display 200 may include more or less transmissive pixel arrays 230 organized into differing combinations of rows and columns. As such, in embodiments having a one-to-one ratio of illumination sources 220 to transmissive pixel arrays 230, the number and layout of illumination sources 220 on illumination layer 205 may also vary. While FIG. 2 does not illustrate intervening layers between the three illustrated layers for the sake of clarity, it should be appreciated that embodiments may include various intervening optical or structural sub-layers, such as lens arrays (e.g., Fresnel lenses 217, lens layers 221, etc.), transparent substrates and spacer supports to provide mechanical rigidity and optical offsets, protective layers, or otherwise.

Transmissive pixel arrays 230 are switched under control of a display controller to modulate the lamp light and project image portions 250 onto a backside of screen layer 215. In various embodiments, screen layer 215 includes matte material (or other diffusing material suitable for rear projection) that is disposed over a transparent substrate providing mechanical support. As illustrated in FIG. 3A, screen layer 215 includes an array of Fresnel lenses 217 that bend the display light to be substantially normal prior to incidence upon a diffusion layer. The Fresnel lenses 217 improve the angular brightness uniformity of display light exiting screen layer 215 while the diffusion layer increases viewing angles. Image portions 250 collectively blend together on screen layer 215 to present a unified image to a viewer from the viewing side of screen layer 215 that is substantially without seams. In other words, the images created by transmissive pixel arrays 230 are magnified as they are projected across separation 255 (e.g., 10 mm) between display layer 210 and a diffusion layer of screen layer 215. The image portions 250 are magnified enough to extend over and cover spacing regions 235 forming a seamless unified image. The magnification factor is dependent upon separation 255 and the angular spread of the lamp light emitted by illumination sources 220. In one embodiment, image portions 250 are magnified by a factor of approximately 1.5, though other magnification factors may be implemented. In one embodiment, the display light has a divergence angle of 40 degrees at the corners of each transmissive pixel array 230 and 30.7 degrees at the middle of a side of each transmissive pixel array 230. Not only does the unified image cover the internal spacing regions 235B, but also covers the perimeter spacing regions 235A. As such, display panel 200 may be positioned adjacent to other tileable display panels 200 and communicatively interlinked to form larger composite seamless displays, in which case the unified image generated by a single tileable display panel becomes a sub-portion of a multi-tile unified image (e.g., see FIG. 3B).

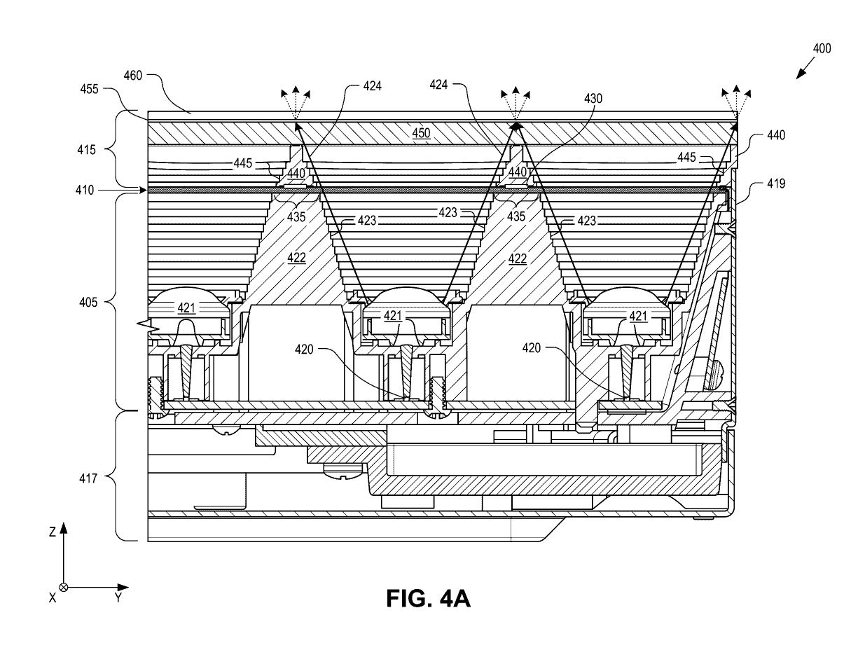

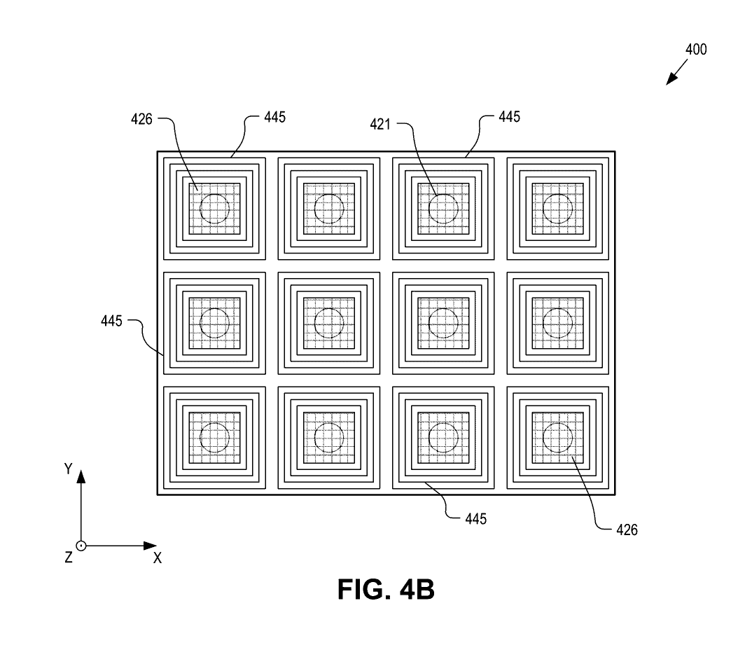

FIGS. 4A and 4B illustrate a portion of a tileable display panel 400 having a frameless display screen, in accordance with an embodiment of the disclosure. FIG. 4A is a cross-sectional illustration (side view) while FIG. 4B is a cross-sectional illustration (top view) of the same. Tileable display panel 400 represents one possible implementation of tileable display panel 200. The illustrated embodiment of tileable display panel 400 includes an illumination layer 405, a display layer 410, a screen layer 415, an electro-mechanical layer 417, and a perimeter bezel 419. The illustrated embodiment of illumination layer 405 includes illumination sources 420, lenses 421, lower spacer supports 422, and light baffles 423 having baffled sides that each surround a portion of an optical pathway 424. The illustrated embodiment of display layer 410 includes transmissive pixel arrays 426 (see FIG. 4B) through which the optical pathways 424 pass and electronics 430 disposed in spacing regions 435. The illustrated embodiment of screen layer 415 includes upper spacer supports 440, light baffles 445 having baffled sides that each surround a portion of optical path 424, a transparent substrate 450, a Fresnel lens layer 455, and a diffusing layer 460.

During operation, illumination sources 420 emit divergent lamp light up through lenses 421. Lenses 421 help control the divergence of the lamp light to carefully align with and illuminate the backsides of transmissive pixel arrays 426 on display layer 410. Since tileable display panel 400 is a rear projection display panel that seamlessly stitches image portions together, the separation distance between illumination sources 420 and their corresponding transmissive pixel arrays 426, as well as, the separation distance between transmissive pixel arrays 426 and transparent substrate 450 upon which the diffusing layer 460 is disposed, should be uniformly maintained across the two dimensional surface of tileable display panel 400. Without tightly controlled uniformity in these fixed offset distances, the image portions will not lineup to provide a seamless image either intra-panel or inter-panel.

Accordingly, the illustrated embodiment of tileable display panel 400 includes an array of upper spacer supports 440 and an array of lower spacer supports 422 evenly disposed across the two dimensional area of tileable display panel 400 to evenly support and closely maintain these fixed offset distances. The uniform distribution of upper and lower spacer supports 440 and 422 hold display layer 410 flat without asserting undue stresses on this layer that can cause warping and negatively affect the optical quality of transmissive pixel arrays 426 disposed therein. For example, in the illustrated embodiment, upper spacer supports 440 are disposed on the top side of spacing regions 435 between transmissive pixel arrays 426 while lower spacer supports 422 are aligned directly below upper spacer supports 440 to carry the load supported by upper spacer supports 440 down to electro-mechanical layer 417. This direct load bearing alignment reduces stresses on display layer 410 while providing interior support for display layer 410 and transparent substrate 450 to reduce or eliminate sagging and stresses that would be present if display layer 410 and transparent substrate 450 were only supported around the perimeter by perimeter bezel 419.

In one embodiment, upper spacer supports 440 and lower spacer supports 422 are fabricated of metal (e.g., aluminum) to provide a light weight, rigid, and thermally stable support. In one embodiment, transparent substrate 450 is a glass substrate (e.g., 4 mm thick sheet of glass) to also provide a rigid, transparent, and thermally stable mechanical support to diffusing layer 460 upon which the image is projected. Of course other materials that provide rigid and thermally stable support may also be implemented.

In the illustrated embodiment, upper spacer supports 440 and lower spacer supports 422 have a truncated cone profile shape that is wider towards the bottom or backside of tileable display 400 and narrower towards the top or viewing side of tileable display 400. This truncated cone profile allows optical pathways 424 to expand as the image portions are magnified to cover and overlap the spacing regions 435 and perimeter bezel 419. The thickness of transparent substrate 450 can further be selected in connection with the divergence angle of the display light to achieve the requisite expansion and overlap to conceal the intervening spacing regions 435, interior upper spacer supports 440, perimeter upper spacer supports 440, and perimeter bezel 419. Furthermore, in the illustrated embodiment, transparent substrate 405 along with Fresnel lens 455 and diffusing layer 460 extend all the way to the perimeter edge of tileable display panel 400 and overlap perimeter bezel 419. This provides a frameless screen that is entirely occupied by the aligned image portions.

In the illustrated embodiment, optical pathways 424 are air cavities or air spaces defined by light baffles 423 and 445 having baffled or stepped sides. Light baffles 445 are disposed above display layer 410 while light baffles 423 are disposed below display layer 410. In one embodiment, light baffles 423 and 445 are inserts (e.g., plastic inserts) having a dark or matte black color to reduce stray light reflections. In another embodiment, the light baffles 423 and 445 may be formed into the side surfaces of lower spacer supports 422 and upper spacer supports 440, respectively. For example, lower spacer supports 422 may form an egg carton like array into which black plastic light baffles 423 are inserted. Similarly, in this example, upper spacer supports 440 may form an egg carton like array into which black plastic light baffles 445 are inserted.

In the illustrated embodiment, perimeter bezel 419 does not wrap around the edges or front side of transparent substrate 450. Accordingly, other techniques of bonding transparent substrate 450 to the lower layers of tileable display panel 400 are used. In one embodiment, recesses are formed in the top side of upper spacer supports 440 to provide a dimple for liquid adhesive to bond transparent substrate 450 to upper spacer supports 440. In other embodiments, transfer tape or other adhesive materials may be used. Correspondingly, in some embodiments, the bottom side of upper spacer supports 440 may also include recesses or cavities to provide room for surface mount electronics 430 and optionally to apply adhesives for bonding to display layer 410.

Although not illustrated in FIG. 4A, in various embodiments, one or more lenses structures may be optionally disposed within the air spaces cavities defined light baffles 445 to provide further lensing power to optical pathways 424 above display layer 410.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A tileable display panel comprising:
a display layer including a plurality of transmissive pixel arrays offset from each other by spacing regions;
an illumination layer including a plurality of illumination sources each aligned to illuminate a backside of a corresponding one of the transmissive pixel arrays; and
a screen layer disposed over the display layer with each of the transmissive pixel arrays aligned to project an image portion onto a corresponding portion of the screen layer, wherein the screen layer includes:
a transparent substrate; and
an array of upper spacer supports to support the transparent substrate a first fixed distance from the display layer, wherein each of the upper spacer supports is positioned on one of the spacing regions.

2. The tileable display panel of claim 1, wherein the transparent substrate extends over and covers a perimeter bezel of the tileable display panel.

3. The tileable display panel of claim 1, wherein the illumination sources are configured to illuminate the backside of the transmissive pixel arrays with divergent light that expands the image portions of adjacent transmissive pixel arrays to overlap and conceal an intervening one of the upper spacer supports.

4. The tileable display panel of claim 1, wherein the upper spacer supports each have a truncated cone profile shape with a large end supported by the display layer in a corresponding one of the spacing regions and a small end supporting the transparent substrate.

5. The tileable display panel of claim 1, wherein the illumination layer further comprising:
an array of lower spacer supports to support the display layer a second fixed distance from the illumination sources, wherein the each of the lower spacer supports is aligned under a corresponding one of the spacing regions and upper spacer supports.

6. The tileable display panel of claim 5, further comprising:
light baffles having baffled sides surrounding optical pathways that extend between the upper spacer supports and extend between the lower spacer supports.

7. The tileable display panel of claim 5, wherein the upper and lower spacer supports define air spaces through which optical pathways extending from the illumination sources to the transparent substrate pass.

8. The tileable display panel of claim 1, wherein the transparent substrate comprises a sheet of glass and the upper spacer supports are fabricated of metal.

9. The tileable display panel of claim 8, wherein at least a portion of the upper spacer supports each include a recess on a top side interfacing with the transparent substrate to accommodate an adhesive for bonding the transparent substrate to the upper spacer supports.

10. The tileable display panel of claim 1, wherein at least a portion of the spacing regions on the display layer between adjacent ones of the transmissive pixel arrays include electronics for operation of the transmissive pixel arrays.

11. A display panel comprising:
a display layer including a plurality of pixel arrays offset from each other by spacing regions; and
a screen layer disposed over the display layer with each of the pixel arrays aligned to project an image portion onto a corresponding portion of the screen layer, wherein the screen layer includes:
a transparent substrate; and
an array of upper spacer supports to support the transparent substrate a first fixed distance from the display layer, wherein each of the upper spacer supports is positioned on one of the spacing regions.

12. The display panel of claim 11, wherein the transparent substrate extends over and covers a perimeter bezel of the display.

13. The display panel of claim 11, wherein the pixel arrays are configured to output divergent light that expands the image portions of adjacent pixel arrays to overlap and conceal an intervening one of the upper spacer supports.

14. The display panel of claim 11, wherein the upper spacer supports each have a truncated cone profile shape with a large end supported by the display layer in a corresponding one of the spacing regions and a small end supporting the transparent substrate.

15. The display panel of claim 11, further comprising an illumination layer disposed below the display layer, the illumination layer comprising:
a plurality of illumination sources each aligned to illuminate a backside of a corresponding one of the pixel arrays, wherein the pixel arrays comprise transmissive pixel arrays; and
an array of lower spacer supports to support the display layer a second fixed distance from the illumination sources, wherein the each of the lower spacer supports is aligned under a corresponding one of the spacing regions and upper spacer supports.

16. The display panel of claim 15, further comprising:
light baffles having baffled sides surrounding optical pathways that extend between the upper spacer supports and extend between the lower spacer supports.

17. The display panel of claim 15, wherein the upper and lower spacer supports define air spaces through which optical pathways extending from the illumination sources to the transparent substrate pass.

18. The display panel of claim 11, wherein the transparent substrate comprises a sheet of glass and the upper spacer supports are fabricated of metal.

19. The display panel of claim 18, wherein at least a portion of the upper spacer supports each include a recess on a top side interfacing with the transparent substrate to accommodate an adhesive for bonding the transparent substrate to the upper spacer supports.

20. The display panel of claim 11, wherein at least a portion of the spacing regions on the display layer between adjacent ones of the pixel arrays include electronics for operation of the pixel arrays.
